(19) United States
(12) Patent Application Publication
(10) Pub. No.: US 2016/0231888 A1
(43) Pub. Date: Aug. 11, 2016

(54) Communication Interface

(71) Applicant: Apps Interactive Limited, Leicester (GB)

(72) Inventor: Rohith Govindraj, Leicestershire (GB)

(21) Appl. No.: 15/017,599

(22) Filed: Feb. 6, 2016

(30) Foreign Application Priority Data
Feb. 11, 2015 (GB) 1502277.5

(51) Int. Cl. G06F 3/0482; G06F 3/0486; G06F 3/0485; G06F 3/0484

(52) U.S. Cl. CPC G06F 3/0482; G06F 3/04842; G06F 3/0486; G06F 3/0485; G06F 3/04847

(57) ABSTRACT

A communication interface for allowing interaction between two or more users. The communication interface has a graphical user interface (GUI) for displaying content in a multi-layered environment and an interaction engine for facilitating interactions between a user and one or more user contacts. The interaction engine facilitates voice, video and file sharing interactions between the user and one or more user contacts through the GUI, and is arranged to be in an out-of-call mode or in an in-call mode in relation to voice and video interactions of the user. The GUI displays a contact list containing a plurality of user contacts, where one of the plurality of contacts is a selected contact. The GUI displays a dashboard containing a plurality of options for interacting with the selected contact, each option enables the user to interact with the selected contact by voice, video or file sharing and editing interactions.

### FIELD OF THE INVENTION

This application claims priority to GB1502277.5 filed on Feb. 11, 2015, the entire contents of which are incorporated by reference herein.

### FIELD OF THE INVENTION

The invention relates to a communication interface, and in particular to an application that allows users to communicate via video and voice calls and to share files.

### BACKGROUND OF THE INVENTION

Conventional communications applications allow a user to establish a voice or a video call with a contact. Separate applications allow a user to send messages, and share files. However, conventional communications applications have only inefficient and time consuming ways for a user to share files. Users of these conventional applications are frustratingly required to leave the application and open another application in order to find a desired file to share making the voice or video call longer than necessary and disjointed. The use of video conferencing and remote collaborative working tools can be made much more intuitive and useful.

Additionally, for a file to be edited by the user and the recipient using conventional communications applications, a user is required to close the file, then, for example, attach it to an email to send it to the recipient. The recipient is then required to open an application for accessing their email, open the received email, open the attached file, edit the attachment and save the attachment before resending it to the user. This whole process is long, tedious and disruptive, especially should the user and the recipient be in a video or voice call.

Hence, there is a need for a communication interface which provides a fluid, interactive, dynamic way for a user to communicate, share and work on files with a chosen recipient or recipients whether or not in a voice or video call.

### SUMMARY OF THE INVENTION

A first aspect of the invention provides a communication interface for allowing interaction between two or more users. The communication interface has a graphical user interface (GUI) and an interaction engine for facilitating interactions between a user and one or more user contacts. The interaction engine facilitates voice, video and file sharing interactions between the user and one or more user contacts through the GUI, and is arranged to be in an out-of-call mode or in an in-call mode in relation to voice and video interactions of the user. The GUI displays a contact list containing a plurality of user contacts, where one of the plurality of contacts is a selected contact. The GUI displays a dashboard containing a plurality of options for interacting with the selected contact, each option arranged to enable the user to interact with the selected contact by voice, video or file sharing interactions. The GUI also displays, on selection of an option relating to file sharing and depending on the selection, a window so the user is able to create a file for sharing, or a secondary dashboard comprising an item representing a file for sharing with the selected contact. The interaction engine shares the file for sharing with the selected contact on receipt of a sharing gesture from the GUI in relation to the window or item, whether or not the interaction engine is in the out-of-call mode or the in-call mode.

In this way, it is easier and more intuitive for a user to share files with contacts. File creation is included within the communication interface in a separate window which is easily shared with the selected contact by the sharing gesture. Alternatively, if a file already exists, then a quick and easy gesture mechanism is provided to allow the user to share the file with the selected contact. A very flexible system is provided which allows user-to-user voice, video and file-sharing interactions in an integrated communication interface that provides a way in which a user can communicate with others without the need to leave the GUI of the communication interface. The system is flexible in that new files are able to be created in a new window and the new files are shared within the application, while existing files such as PDF documents or eBooks are able to be shared. Importantly, the sharing of the files is achieved very quickly and intuitively by a sharing gesture which automatically shares a file with a selected contact. File sharing is achieved both in an out-of-call mode and simultaneously with a video or voice interaction in an in-call mode.

Preferably the file for sharing is capable of being created and edited by the user and the selected contact at the same time.

Optionally, the sharing gesture is one of the following: a tap gesture, a flick gesture, a two-finger slide gesture or a drag-and-drop gesture.

Preferably, the sharing gesture is a drag-and-drop gesture or a two-finger slide gesture when the sharing gesture relates to the window. In this way, the user can quickly and easily share a created filed with a selected contact.

According to one iteration, the sharing gesture may be a drag-and-drop gesture when the sharing gesture relates to the window and the interaction engine is in an out-of-call mode.

As an example, the drag-and-drop gesture may finish on the contact list. In this way, the user can share files with the selected contact efficiently and quickly. The user is not required accurately to end the drag-and-drop on a specific contact so there is no risk of sharing the files with another contact of the contact list since the selected contact will receive any file landing on the contact list until the selected contact has been reassigned. There is also no requirement for the user to repeatedly select the selected contact to whom they want to share files with, this shortcut results in a fluid sharing process with the user saving time and increasing their overall efficiency since the user can complete the task of sending files quickly. As a result, the user moves on to their next task faster.

Alternatively, the drag-and-drop gesture may finish on the selected contact in the contact list.

Optionally, the drag-and-drop gesture can change the selected contact to a desired contact in the contact list by moving over the desired contact prior to finishing the sharing gesture i.e. “dropping” the file for sharing. In this way, the user can cut out the need separately to select which contact they wish to send their file for sharing to and instead, the user can simply finish the drag-and-drop gesture on the desired recipient. As a result, the user saves time and tasks are completed more efficiently.

According to one iteration, the sharing gesture is a two-finger slide gesture when the sharing gesture relates to the window and the interaction engine is in an in-call mode with the selected contact. Preferably, the two-finger slide gesture is in an upward direction in relation to the user's perspective of the GUI. The two-finger slide gesture is intuitive and smoothly completes the sharing process whilst giving the user the feeling they are pushing the file through the screen to cause the file to appear on the GUI of the selected contact.

In an alternative iteration, the sharing gesture may be a one-finger slide gesture.

Alternatively, the two-finger slide gesture may be in one of the following directions: right-hand, left-hand or downwards direction in relation to the user's perspective of the GUI. Preferably, the window is shared with the selected contact so that the selected contact is shown the window.

According to a preferred iteration, the sharing gesture is a tap gesture or a flick gesture when the sharing gesture relates to the item. For example, the sharing gesture is a tap gesture or a flick gesture when the sharing gesture relates to the item and the interaction engine is in an in-call mode or an out-of-call mode. Preferably, the sharing gesture is a flick. Optionally, the flick gesture is in an upward direction in relation to the user's perspective of the GUI. Alternatively, the flick gesture may be in a right-hand or left-hand direction in relation to the user's perspective of the GUI.

In this way, sharing saved files with a contact is quick and easy for the user. The tap and flick sharing gestures are intuitive, dynamic and quick for the user to complete. The user is given the feeling that the files that are shared are being sent out of the top, back or side of the GUI, or even through the GUI.

Preferably, the contact list is a scrollable contact list. Optionally, scrolling the scrollable contact list reassigns the selected contact to another contact. In this way, the need to scroll and then select the desired selected contact is cut out, and instead, the contact list can be scrolled until the desired selected contact is in the position of the selected contact thereby becoming the selected contact. In this way, sharing different files with different contacts is made quicker and the process smoother since the user simply has to scroll the contact list and then use a sharing gesture such as a flick or tap to share the file with the intended recipient.

In one iteration, the selected contact is centrally displayed in the scrollable contact list. In this way, the selected contact is emphasised and the user is fully aware of which contact is the selected contact.

In a further iteration, the scrollable contact list is one of a linear list or a wheel. Optionally, the GUI displays only a part of the scrollable contact list. In this way, the GUI remains clear and concise.

As an example, the scrollable contact list may be continuously scrollable. In this way, the process of finding a contact is smooth and not disrupted by reaching the end of the contact list and needing to scroll in reverse to find the desired contact.

Preferably, the GUI is arranged to allow the contact list to slide in and out of view. In this way, more space can be created on the GUI by hiding the contact list and bringing it back into view when necessary.

In a preferred iteration, the GUI provides a multi-layered environment for the contact list, dashboard, and windows. Each window may be non-transparent, semi-transparent (where any objects below and overlapped by the window appear faded) or transparent (where objects below and overlapped by the window are seen at full brightness). Where the windows are semi-transparent or transparent, the background of the window may be the only part which allows objects underneath to be seen. For example, any user data displayed by a window is non-transparent, such as lines in a drawing. In this way, the effect of any overlap of layers to a user's view of all of the windows is minimised and the user can remain within the application whilst completing a number of different tasks. The user is also aware of any files that are open and either being shared with a selected contact or being worked on by the user themselves. Since neither the contact list, dashboard nor any of the windows block each other entirely completely from view, the user can clearly interact with the GUI and is given a cleaner and clear display in which to work. The latest window opened may appear as a top layer of the multi-layered environment of the GUI.

Preferably, each window is moveable and resizable independently from other objects in the GUI. In this way, if the user wishes to concentrate on one window, said window can be enlarged and take up more of the display making it easier for the user to complete work. Equally any windows that the user does not currently need or want to view can be downsized and made less prominent on the display. The user is able to customise the GUI for their own personal needs. Any window that a user touches is brought to the top of the multi-layered environment.

In one iteration, during a video or voice call with a selected contact, the GUI displays incoming video data from the selected contact. The GUI may also display location information of the selected contact, which can also be done when in an out-of-call mode. Preferably, the GUI overlays any windows that are created for file sharing or which are received from the selected contact in the incoming video data. Optionally, the GUI displays the most recently created window uppermost in the display. As an example, the most recently created window may be displayed as the top layer of a multi-layered environment displayed by the GUI. Alternatively, the most recently created window may be displayed in the top half of the display in relation to the user's perspective of the GUI. In this way, the user can easily access the most recent and perhaps most relevant file that has been shared and can work fluently and efficiently.

In a slight variation, multiple users, each using an electronic device upon which the communication interface is implemented, can take part in a multi-user video call. In a multi-user video call each GUI (associated with each communication interface implemented on the separate electronic devices of each user) displays video data from the other users taking part in the multi-user video call. The video data of each user may be displayed by the GUI of each communication interface in a window, where one window is associated with one user. Alternatively, the video data of each user may take up a portion of a main display area of the GUI of each communication interface.

A user of the communication interface may take part in a video or voice call with a selected contact. The user may add contacts to the video or voice call by selecting additional contacts from the contact list. The initial selected contact remains a selected contact during the video or voice call if the contact list is scrolled to select additional contacts (to create multiple selected contacts). The features previously described associated with a video or voice call between the user and one selected contact also apply when there is more than one selected contact in a video or voice call. For instance, file sharing is actioned for all the selected contacts in the same way using the same gestures. Additionally, location information may be displayed for each or all of the selected contacts. As explained above, each selected contact taking part in a video call will have their own device upon which the communication interface is implemented and an associated GUI is displayed.

Preferably, the GUI is arranged to allow the dashboard to slide in and out of view. In this way, more space can be created on the GUI by hiding the dashboard and bringing it back into view when necessary. Optionally, the dashboard may slide into view when the contact list is opened and slide out of view when the contact list is closed. In this way, the user can easily start creating or sharing files with a selected contact. The overall feel of the GUI is sleek with fluid movement.

In a preferred iteration, the plurality of options on the dashboard include one or both of a voice or video call initiation option with the selected contact; and one or a combination of the following file-sharing options: photo sharing; video sharing; website sharing; editable text file sharing; doodle sharing; animation sharing; greeting sharing; eBook sharing; stored file sharing; PDF sharing; slide-show sharing; event invitation sharing; and game-play sharing. Doodles, greetings, text documents, slide show presentations, spreadsheets, event invites, and other file formats can be created and edited by the user. A greeting can be created by adding text, a photo or a video. Further to this, doodles, greetings, text documents, slide show presentations, spreadsheets, event invites and other file formats can be created and edited simultaneously by two or more users of the communication interface (i.e. a user and a selected contact) working together. The creation and editing of files, by the user or by the user and one or more selected contacts, can be performed when the interaction engine of the user and the one or more selected contacts is in an in-call mode (video/voice call taking place) or in an out-of-call mode (no voice/video call taking place). Whilst files are created and edited by two or more users, each using an electronic device upon which the communication interface is implemented, the two or more users may simultaneously use other features of their respective communication interfaces displayed by each of their GUIs, such as, browsing a webpage or creating a design using the doodle option. The two or more users may receive data from multiple windows at the same time. For example, receiving news stories from a webpage displayed in a first window whilst playing a video displayed in a second window and sending an email using a third window, or, receiving video data from two different contacts with whom a three-way multi-user video call is taking place.

Optionally, the plurality of options on the dashboard include one or a combination of the following: online video links such as YouTube (RTM) links, sponsored webpage links such as Groupon (RTM).

Preferably, one or a combination of the following options cause the GUI to display a window: photo sharing; video sharing; website sharing; editable text file sharing; doodle sharing, event invitation sharing.

Preferably, one or a combination of the following options cause the GUI to display a secondary dashboard of items: photo sharing; video sharing; website sharing; animation sharing; greeting sharing; eBook sharing; stored file sharing; PDF sharing; slide show sharing; event invitation sharing; game-play sharing.

Optionally, when one of the following options is chosen: photo sharing; video sharing; website sharing; animation sharing; greeting sharing; eBook sharing; stored file sharing; PDF sharing; slide show sharing; event invitation sharing, game-play sharing, a secondary dashboard may display favourited items associated with the chosen option. Alternatively, the secondary dashboard may display the most recent shared items associated with a selected option.

The secondary dashboard may display bookmarked web pages. The secondary dashboard may display purchasable items whereby the purchasable items may be stored on the device. Optionally, the purchasable items may be downloaded from a server and shared with contacts.

Optionally, the GUI replaces the dashboard with the secondary dashboard on selection of an item-generating option from the dashboard. In this way, the GUI remains concise and uncluttered.

In a preferred iteration, the GUI displays a history of interactions including voice and video calls and file sharing between the user and the selected contact. Preferably, the GUI displays the history of interactions when the GUI receives a history gesture on the selected contact. For example, the history gesture may be a tap or a click on the selected contact. In this way, the user can readily access files that were shared in the past. This means the user can work in an efficient and productive manner without the need arduously to search for files.

Optionally, the GUI may display a history of interactions between the user and multiple contacts, selecting an entry on the history of interactions may bring the contact associated with the entry to the centre of the contact list. In this way, a further response is able to be carried out by the user in a quick and easy manner. Alternatively, the contact list may not be visibly displayed.

Optionally, the GUI may display the location of each of the contacts of the contact list. The GUI may display the location of a selected contact during a video or voice call. The GUI may display the location of a selected contact upon selection of the selected contact. Adverts, services and the options displayed to the user may be based on the location of the user.

Preferably, the GUI displays the contact list along one edge of the GUI and displays the dashboard along another edge of the GUI, such that the contact list and dashboard define a main display area in which the GUI displays any history information, incoming video data and windows. For example, the contact list may be displayed along a right-hand edge of the GUI from the perspective of the user. As a further example, the dashboard may be displayed along a bottom edge of the GUI from the perspective of the user.

In one iteration, when the GUI displays a window which has been shared with the selected contact, the GUI detects a user pointing gesture within the window, and the interaction engine shares a digital finger representing the user pointing gesture with the selected contact. Optionally, the user pointing gesture is one of a cursor hover, a touch gesture and a movement gesture. In one example, the digital finger may be a digital image representing the user. Preferably, the digital finger may include an identifier identifying the user. Optionally, a digital finger associated with the selected contact is shown on the user's window. As an example, the window which has been shared may relate to one of the following: an eBook, a text document, a spreadsheet, a PDF document, and a slide show presentation. In this way, the sharing of a file between the user and a selected contact has increased interactivity as both the user and selected contact is aware of each other's movements. The communication between the user and selected contact is improved as both voice and sight can be relied upon for communication.

In a further iteration, when the user is interacting with one or more selected contacts (each using an electronic device upon which the communication interface is implemented) in a voice or video call, or a group of contacts associated with a selected contact, multiple digital fingers (one digital finger associated with each selected contact and each contact of the group, respectively) may be displayed by the GUI of the user. The multiple digital fingers may be displayed by the GUI associated with the communication interface implemented on each contact's electronic device improving the interactivity of the group interaction.

In a preferred iteration, the communication interface can be a self-contained application for a computing device. Preferably, the application is for use on a smart phone, tablet computer, desktop computer, laptop computer or a smart wearable device.

Optionally, the GUI may be a touch user interface or a gesture recognition interface.

In one iteration, the shared files may be stored within the communications interface.

In another iteration, the shared files may be stored on the user's device.

In another iteration, the shared files may be stored on a central server. In a further iteration, the shared files may be stored on third party servers.

According to another aspect of the invention, a contact list containing a plurality of contacts is provided that is continuously scrollable in both an upward and a downward direction. One of the plurality of contacts is a selected contact. The selected contact may be centrally displayed in the contact list. Only a part of the contact list is displayed at one time. The contact list may be slid in and out of view. The contact list is displayed along one edge of a GUI. The contact list may be linear or have a wheel shape and scroll continuously in both a clockwise and an anti-clockwise direction. Optionally, the selected contact may be displayed at the top of the contact list. Optionally, the whole of the contact list is displayed at one time. Optionally, the selected contact may be reassigned through scrolling of the contact list. Optionally, the contact list may include a search contact option. As another example, the contact list may display contacts in order of most recent interaction.

According to another aspect of the invention, a digital finger is provided that represents a user pointing gesture of a user within a window on a screen of the user. The window is shared between the user and a selected contact of the user. The window is shown on the screen of the user. A corresponding window is shown on the screen of the selected contact. The digital finger is shown on the window displayed to the selected contact. The user pointing gesture may be a touch gesture. The digital finger shows the selected contact where the user has touched the window and any movements of the touch of the user within the window. The digital finger may include an identifier identifying the user. The identifier may be a picture of the user. The window which has been shared may relate to one of the following: an eBook, a text document, a spreadsheet, a PDF document, a webpage, a doodle and a slide show presentation. Optionally, the user pointing gesture may be a cursor hover or a movement gesture. Alternatively, the identifier may be the name, nickname, ID number, location of the user, or even a colour of the user. Optionally, a digital finger associated with the selected contact is shown on the user's window. In a multi-contact interaction multiple digital fingers each associated with one of the contacts may be shown on the user's window.

Preferably, a touch event of a user in a window is represented by co-ordinates (x, y) using an axis of the window. The axis of the window may have an origin that corresponds with the bottom left-hand corner of the window. Preferably, the co-ordinates (x, y) are mirrored in a window of a selected contact's GUI as co-ordinates (x′, y′), where the window of the selected contact may have an axis with an origin that corresponds with the bottom left-hand corner of the window. In one example, where the window of the GUI of the user and the window of the GUI of the selected contact are the same size, x=x′ and y=y′. In an alternative example, a window of the GUI of a selected contact may be a different size to a window of the GUI of the user. In this latter case the co-ordinates (x, y) of the window of the user may be scaled up or down to correspond to the co-ordinates (x′, y′) of the window of the selected contact. For instance x′=cx and y′−dy where c and d are constants associated with the scale of the window (axis of the window) of the selected contact.

In this way, the interactivity between the user and a selected contact has increased as both the user and selected contact are aware of each other's movements. The communication between the user and selected contact is improved as voice and sight can be relied upon to convey a point and refer to a part of the shared file. The increase of interactivity also brings with it an increase of productivity and efficiency of completing tasks.

According to another aspect of the invention, a hybrid mail is provided that sends mail to one or more devices using a mobile phone number attached to each device. One or more selectable contacts can be added as recipients. Once the first selected contact has been made a recipient additional selected contacts can be made recipients by scrolling the contact list and selecting. One or more files can be attached to the hybrid mail. The one or more files are attached to the hybrid mail using a user sharing gesture. The user sharing gesture can be a flick gesture or a tap gesture. The files are added to the hybrid mail by flicking or tapping an item representative of each file, where each item is displayed on a dashboard. Files can be removed from the hybrid mail using a downward flick gesture. Recipients may be added using a sideways flick gesture from the contact list towards the hybrid mail. Recipients may be removed using a sideways flick gesture towards the contact list.

In this way, the user can send emails without the need for email identification which is a more convenient and flexible way of using files since mobile telephone numbers are more readily exchanged between two people and often a mobile telephone number is the only data a user may have to allow the user to contact their intended recipient. The sharing gesture allows the files to be attached to the hybrid email quickly avoiding the tedious and long method of attaching files used with conventional emails.

In one iteration of the invention, there is provided a communication interface for allowing a user to create and edit files with one or more selected contacts who are using their own electronic devices upon which the communication interface is implemented. The user and the one or more selected contacts have a shared view of a window in each of their respective GUIs that displays the file to be created or edited. The user and the one or more selected contacts create and edit a file simultaneously. The user and the one or more selected contacts can create and or edit a file during a video/voice call.

### BRIEF DESCRIPTION OF THE DRAWINGS

Embodiments of the invention will now be described with reference to the accompanying drawings, in which:

FIG. 1 is a schematic diagram of a communication interface 100.

FIG. 2 is a flowchart showing how the communication interface 100 of FIG. 1 shares files with a selected contact from a user perspective.

FIG. 3 is a schematic diagram illustrating a system in which the communication interface 100 of FIG. 1 is implemented.

FIG. 4A is a schematic diagram illustrating a drag-and-drop sharing gesture of a GUI when an interaction engine 200 is in an out-of-call mode.

FIG. 4B is a schematic diagram illustrating another drag-and-drop sharing gesture of the GUI when the interaction engine 200 is in an out-of-call mode.

FIGS. 4C and 4D are schematic diagrams illustrating an alternative drag-and-drop sharing gesture of the GUI when the interaction engine 200 is in an out-of-call mode.

FIG. 5 is a schematic diagram illustrating a two-finger slide sharing gesture of the GUI when the interaction engine 200 is in an in-call mode.

FIG. 6 is a schematic diagram illustrating a flick sharing gesture of the GUI when the interaction engine 200 is in an out-of-call mode or in an in-call mode.

FIG. 7A is a schematic diagram which shows a vertical linear contact list 110 of the GUI.

FIG. 7B is a schematic diagram which shows a wheel contact list 110 of the GUI.

FIG. 7C is a series of three schematic representations illustrating a sliding feature of the contact list 110.

FIG. 8 is a series of three schematic representations illustrating a scrolling feature of the contact list 110.

FIG. 9 is a schematic diagram shows a history of interactions 160 of the GUI.

FIG. 10 is a series of three schematic representations illustrating a sliding feature of a dashboard 130.

FIG. 11 is a schematic diagram which shows a secondary dashboard 135.

FIG. 12A is a schematic diagram which shows a multi-layered environment of the GUI.

FIG. 12B is a schematic diagram which shows a multi-layered environment of the GUI when a video call is taking place.

FIG. 12C illustrates a multi-user video call.

FIG. 13A is a schematic diagram illustrating a digital finger feature of the GUI.

FIG. 13B is a schematic diagram illustrating how a touch event in a user GUI is accurately reproduced in a selected contact GUI.

FIG. 13C is a schematic diagram illustrating the reproduction of co-ordinates (x, y) in a window of a selected contact device using co-ordinates (x′, y′) when the window of the selected contact device is not the same size as the window containing co-ordinates (x, y).

FIG. 14 is a schematic diagram which illustrates a digital finger feature of the GUI in a multi-user voice call scenario.

FIG. 15 is a schematic diagram which shows a device 400 on which the communication interface 100 is implemented.

FIG. 16 is a schematic diagram which shows a group of secondary contacts and a subgroup of tertiary contacts.

FIG. 17 is a schematic diagram illustrating the hybrid mail feature of the GUI.

### DETAILED DESCRIPTION

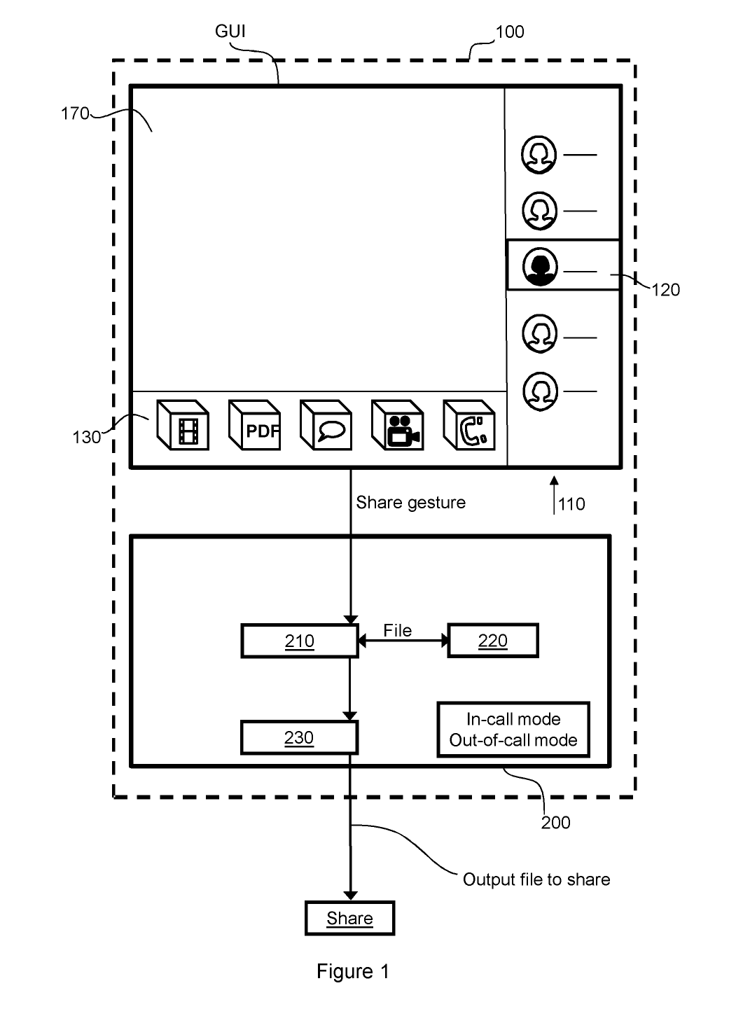

FIG. 1 shows a communication interface 100 that has a graphical user interface GUI and an interaction engine 200. The GUI displays a contact list 110 that contains a plurality of contacts and a dashboard 130 that contains a plurality of options for interaction. The contact list 110 and the dashboard 130 define a main display area 170. The contact list 110 is displayed along a right hand edge of the GUI from the perspective of a user and the dashboard 130 is displayed along a bottom edge of the GUI from the perspective of the user. The plurality of contacts of the contact list may be displayed in order of most recent interaction.

The interaction engine 200 is shown in simplified form and includes a processor 210, memory 220 and a transceiver 230. The interaction engine 200 can be in an in-call mode or in an out-of-call mode. In-call mode is when the user is in a voice or video call with one or more of the plurality of contacts in the contact list 110 through the communication interface 100. Out-of-call mode is any other time during which the communication interface 100 is being used.

A user of the GUI selects a contact from the contact list 110. This contact is the selected contact 120. The plurality of options of the dashboard 130 enable a user to interact with the selected contact 120 by voice or video call or by file sharing interactions.

When a user selects a file sharing option from the dashboard 130, depending on the selection, either a window (indicated as 140 in subsequent drawings) will be displayed by the GUI in the main display area 170 so the user can create a file for sharing with the selected contact 120, or, a secondary dashboard (indicated as 135 in subsequent drawings) containing items representing files for sharing (or folders that contain one or more files for sharing) will be displayed in place of dashboard 130 so that the user can select an item representative of a file for sharing.

The secondary dashboard 135 may display favourited items or most recently shared items.

The items displayed by secondary dashboard 135 could be items for sale, or sponsored content.

The window displayed for creating a file for sharing is resizable and can be moved around the GUI.

When a user inputs a sharing gesture into the GUI the interaction engine 200 receives a signal to share the file for sharing that was either created or selected by the user.

The processor 210 of the interaction engine 200 receives the sharing gesture from the GUI that was input by the user. The file for sharing is requested from the memory 220 and sent to the transceiver 230. The file for sharing is output by the transceiver 230 to a network (indicated as cloud network 360 in subsequent drawings) and shared with the selected contact 120. The file for sharing may be shared when the interaction engine is in an in-call mode i.e. the sharing takes place simultaneously with a voice or video call.

In one practical example, the communication interface 100 may be used by medical practitioners. Here, a group of doctors and consultants in different geographical locations may hold a video conference using their respective communication interface 100 and quickly, easily, and simultaneously share CT scans or other data files relating to a patient whilst taking part in the video call. The group of doctors and consultants are all able to see the CT scans simultaneously. The CT scans and other data files are displayed in separate, resizable and moveable window in a multi-layered environment. As the conversation moves on over time and more files are shared, the most recent file is displayed at the top of the multi-layered environment allowing the doctors/consultants to keep with the flow of conversation with the most relevant shared file automatically appearing in front of them on their device. This allows their thoughts to be combined and possibly a strategy agreed for the patient in a highly efficient and interactive way, thereby saving time and money, and providing better results.

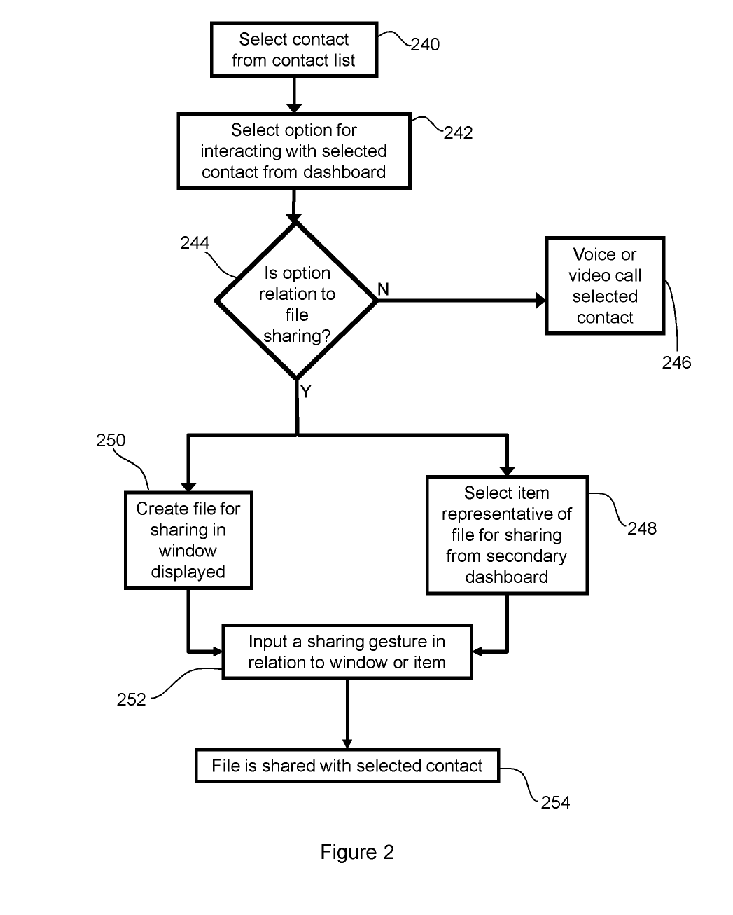

FIG. 2 shows a flow chart of how a user of the communication interface 100 of FIG. 1 interacts with a contact.

In step 240, the user selects a contact from the contact list. At step 242 the user selects an option for interacting with the selected contact from the dashboard. At step 244 the communication interface determines whether the option selected is related to file sharing. If the option is not related to file sharing step 246 commences and a voice or video call is established with the selected contact. However, if the option is related to file sharing, then the user either proceeds to step 248 where an item representative of a file for sharing is selected from the secondary dashboard, or, the user proceeds to step 250 where the user creates a file for sharing in a window displayed by the GUI. At step 252, the user inputs a sharing gesture in relation to the window or the item. At step 254, the file is shared with the selected contacted.

The option selected by the user is related to file sharing if the option is one of the following: photo sharing, video sharing, website sharing, editable text file sharing, doodle sharing, animation sharing, greeting sharing, e-book sharing, stored file sharing, PDF sharing, slideshow sharing, and game play sharing. The option selected by the user may be an online video link or a sponsored link to a website e.g. Groupon (RTM).

Step 248 commences when the file for sharing already exists and, as such, the file sharing option selected is one of the following: photo sharing, video sharing, website sharing, animation sharing, greeting sharing, e-book sharing, stored file sharing, PDF sharing, slideshow sharing, event invitation sharing, and game play sharing.

Step 250 commences when a file for sharing is created by the user and the file sharing option selected is one of the following: photo sharing, video sharing, website sharing, editable text file sharing, event invitation sharing and doodle sharing. The file for sharing may be created by the user together with a contact of the user where the contact of the user uses their own version of the communication interface 100.

In a slight variation, the file creation and sharing process of FIG. 2 may occur whether the interaction engine 200 is in an in-call mode or in an out-of-call mode.

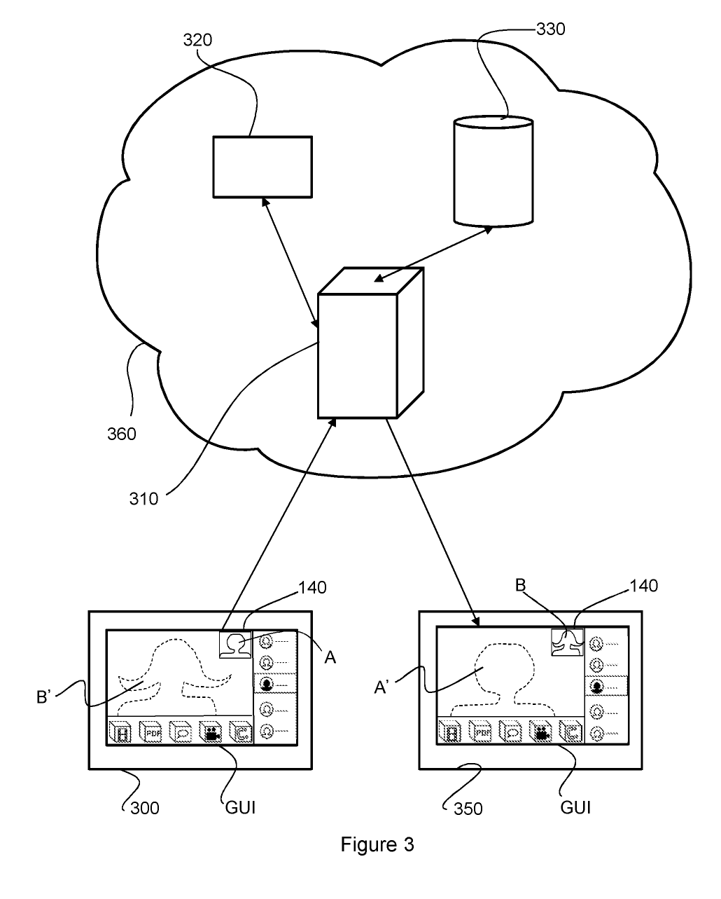

FIG. 3 shows an overview of a system in which the communication interface 100 of FIG. 1 is used. In FIG. 3 a user, person A, is sharing a file in a video call with a selected contact 120, person B. Specifically, a device of the user, the user device 300, and a device of the selected contact, the selected contact device 350, are interacting using cloud network 360. Both the user device 300 and the selected contact device 350 are implementing the communications interface 100 and, subsequently, the GUI.

The cloud network 360 includes a communications server 310, data storage 330, and third party provider 320.

The user, person A, is represented by outline A′ on the GUI of the selected contact. The selected contact, person B, is represented by outline B′ on the GUI of the user. Both outlines A′ and B′ are representative of a live video stream of data. Outlines A′ and B′ are enlarged versions of outlines A and B shown in the GUIs of person A and person B, respectively. Outline A appears in a window 140 in the GUI of person A. Outline B appears in a window 140 in the GUI of person B.

The user device 300 communicates with the communications server 310 to send a file for sharing to the selected contact device 350. The communications server 310 either sends directly the file for sharing to the selected contact device 350 because the user device 300 has provided the file for sharing to the user server 310, or, the user server 310 retrieves the file for sharing from data storage 330 and then sends the file for sharing to the selected contact device 350. The file for sharing is then displayed on the GUI of the selected contact device 350.

Additionally or alternatively, the communications server 310 may retrieve files for sharing from a third party provider 320, an example of this would be using e-books and Amazon's Kindle store.

In some cases, files for sharing may be converted into a format suitable for sharing.

In more detail, the whole of an e-book, or individual pages may be shared with the selected contact 120 from third party provider 320 server via communication server 310 to devices 300 and 350 and then displayed simultaneously by the GUI of each device. The user device 300 is the control device, and any actions carried out by the user on the GUI displaying the e-book on user device 300, such as turning a page, are mirrored on the GUI of the selected contact device 350.

Alternatively, the e-book may be downloaded to the user device 300 for sharing with a selected contact 120 at a later point in time. For example, the e-book may be shared with a selected contact 120 at one of the following points in time: when a video call is established; when a voice call is established, when a multi-user voice call is established, when a multi-user voice call is established, when the user device 300 is within a predetermined range of the location of the selected contact; when the network connection of the user device 300 is at a sufficient strength so that the user device 300 can successfully share the e-book; and when the user device 300 receives a request for sharing from the selected contact device 350.

Other occasions when a file for sharing may be displayed simultaneously on the user device 300 and one or more selected contact devices 350 include the following:

editing a text file;

creating a doodle or picture;

editing a PDF document;

creating a slideshow presentation;

watching a slideshow presentation;

watching a video;

creating an event invitation;

signing a document; and

instant messaging.

The files may be shared live, that is, when the user and the selected contact 120 are in a video call or voice call with each other through the communication interface (in-call mode) or shared when out-of-call. The user and the selected contact 120 (or the user and two or more contacts) can create and edit files together whilst also viewing or using other options provided by the dashboard 130. For example, the user may be watching an online video at the same time as editing a spreadsheet with the selected contact 120. The shared files are not necessarily displayed simultaneously when in an out-of-call mode, but are notified to the selected contact 120 within their communication interface 100 as having been received and are viewable.

As an example, during a video conference through the communication interface 100 between employees of a company, the employees may collaborate and jointly create a slideshow presentation. Clients and employees may also interact in this way.

All the employees can visually interact and edit a presentation simultaneously. The communication interface 100 brings together a group of employees and allows them to create a single presentation without the need to travel. The employees save time and still experience working and interacting in a group. Other files are easily shared during the creation of the slideshow.

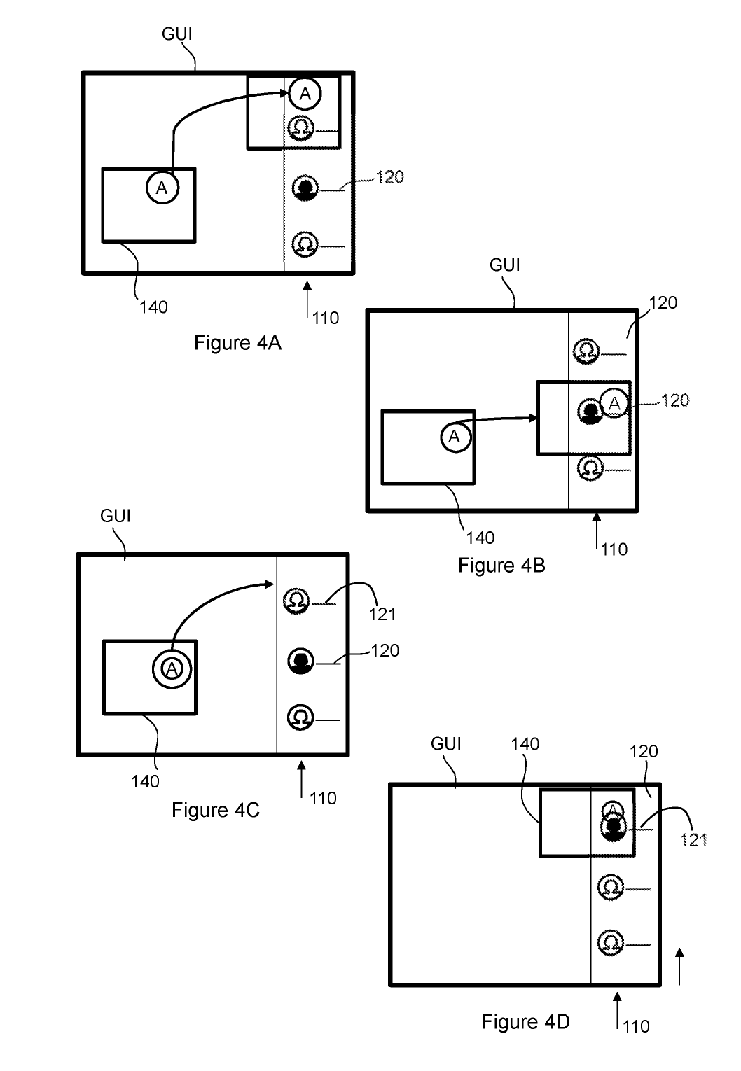

FIGS. 4A, 4B and 4C illustrate how a user can share a file for sharing created in a window 140 when the interaction engine 200 is in an in-call mode or in an out-of-call mode.

In FIG. 4A, the window 140 is sent to the selected user 120 by a drag-and-drop sharing gesture of the user. The one finger touch of the user is represented by the encircled “A”. The user selects the window 140 and moves the window 140 in the direction of the arrow shown in FIG. 4A. The user ends the dragging motion on the contact list 110 (not necessarily over the selected contact 120). The release of the touch of the user “A” sends the file for sharing to the selected contact 120. The window 140 can be dragged to any location on the contact list 110 to send the file for sharing. Optionally, the selected contact 120 can be highlighted.

FIG. 4B shows a drag-and-drop gesture of the user. The dragging motion shown by the arrow ends on the selected contact 120 to send the file for sharing to the selected contact 120.

FIGS. 4C and 4D show that the selected contact 120 can be reassigned by the end point of the dragging motion. In more detail, FIG. 4C shows the selected user 120 in a mid-position of the displayed part of the contact list 110. The user begins the drag-and-drop sharing gesture represented by “A”. FIG. 4D shows the dragging motion of the user ending on contact 121 in the contact list 110. As a result, the contact 121 becomes the selected contact 120 and the file for sharing created on window 140 is sent to contact 121. If a desired contact is not displayed in the visible portion of the contact list 110, then the user is able to hover the drag-and-drop gesture near the top or bottom edges of the contact list 110 automatic scrolling occurs while the hovering continues. The user is then able to complete the drag-and-drop gesture on the desired contact, which then becomes the selected contact 120.

In one example, a file for sharing is an event invitation (or calendar invitation). The user can create an event invitation inside a window 140. Once the details for the event are set, such as the start and end times and the location, the user can select an invitee to the event, namely the selected contact 120, and drag and drop the window 140 on the contact list 110 as shown in FIG. 4A. The release of the touch “A” of the user over the contact list 110 causes the event invitation to be sent to the selected contact 120. When the selected contact 120 receives and accepts the invite the user may receive a notification that the event has been added into a calendar of the user. In the same way, once the selected contact 120 has accepted the event invitation the selected contact 120 may receive notification that the event has been added to their calendar. In other slightly different examples, the event invitation may be shared with a selected contact using the sharing gestures illustrated in FIGS. 4B, 4C and 4D.

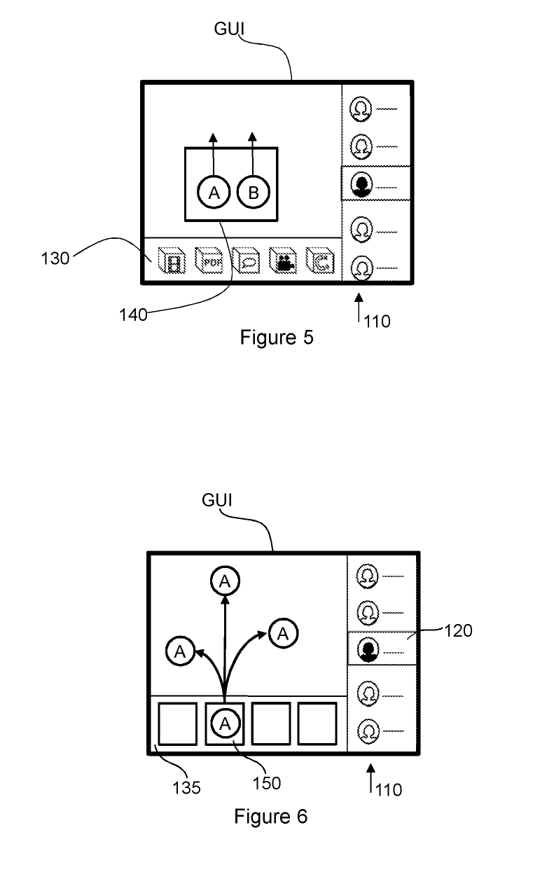

FIG. 5 shows how a user can share a file for sharing created in a window 140 when the interaction engine 200 is in an in-call mode, for example, when the user is in a video call with a selected contact 120.

The window 140 is sent to the selected contact 120 as a result of a two finger sharing gesture of the user. Specifically, FIG. 5 shows the touch of a first finger and a second finger of the user denoted by encircled letters “A” and “B”, respectively. The arrows show the direction in which the sharing gesture is made. The sharing gesture is made in an upward direction in relation to the perspective of the user of the GUI and the sharing gesture is made in a direction away from the starting points (“A” and “B”) of the sharing gesture. If the device upon which the GUI is displayed is lain flat, the “upward” direction corresponds to a direction perpendicular to and away from the dashboard 130 which runs along the bottom edge of the GUI. The user is given the feeling that they are pushing the file through the screen to cause it to appear on the GUI of the selected contact 120. This allows for a very responsive, informative, productive and flowing exchange of information to occur. The inventor believes that this GUI feature will be useful and desirable for all users, but may in particular be useful between medical practitioners and in a business context. The upward direction is preferably defined to be within one of the following: between 20° either side of a straight line that begins at each starting point on the window 140 and runs perpendicular to and away from the bottom edge of the GUI (the arrows of FIG. 5 which protrude from the “start” or “touch” points “A” and “B” illustrates a straight line upward direction); between 40° either side of a straight line that begins at each starting point on the window 140 and runs perpendicular to and away from the bottom edge of the GUI; between 80° either side of a straight line that begins at each starting point on the window 140 and runs perpendicular to and away from the bottom edge of the GUI; and between 90° either side of a straight line that begins at each starting point on the window 140 and runs perpendicular to and away from the bottom edge of the GUI.

Alternatively, the two finger sharing gesture may be replaced by a one finger slide gesture which operates in the same way as the two finger sharing gesture, but having one finger less.

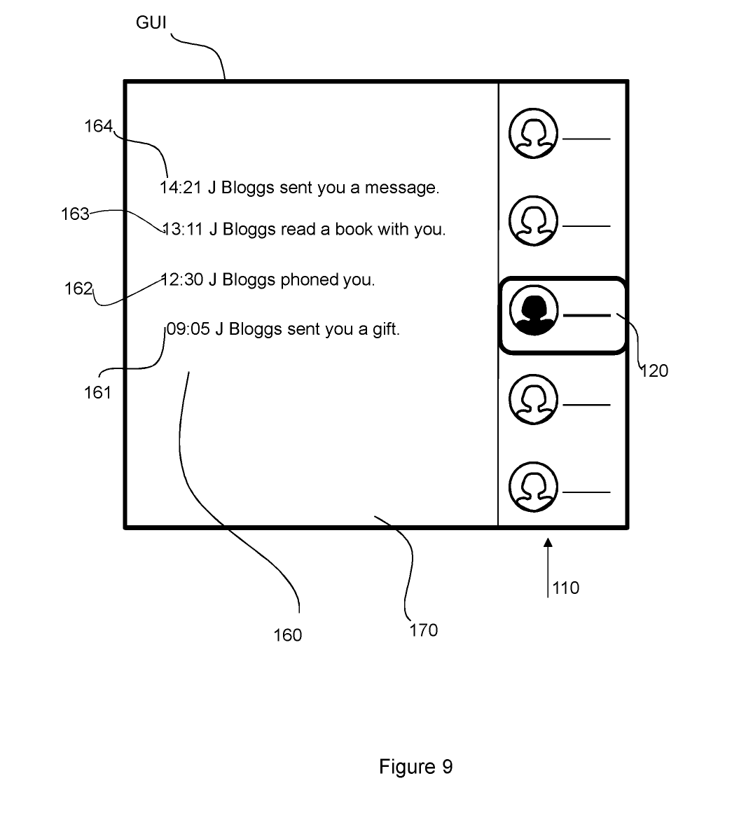

When a user receives a file whilst in a call the user can forward the received file to another contact on the contact list 110. Optionally, received files can be forwarded when out of a call, the files to be forwarded may be chosen from a history of interactions 160 (see FIG. 9) or from the dashboard 130.

In FIG. 6, it is illustrated how a file for sharing, represented by item 150 from the secondary dashboard 135, can be shared by the user with the selected contact 120 when the interaction engine 200 is either in an out-of-call mode or in an in-call mode.

The user may place a single finger “A” on the item 150 in the secondary dashboard 135 and perform a flicking gesture in an upwards direction in relation to the perspective of the user of the GUI. The flick gesture is a single quick movement of a user's finger generally indicative of a user extending their finger quickly from a curled position to a straight position, and does not have to end in a specific place for the item 150 to be shared with the selected contact 120, in contrast to the drag-and-drop sharing gesture described in relation to FIGS. 4A-4C. As shown by the example three arrows of FIG. 6, the flick gesture is in a direction away from the secondary dashboard 135 and may have a varying trajectory and need not be restricted to a straight line or in a generally perpendicular direction in relation to the secondary dashboard 135.

More specifically, the flick gesture is recognised by the GUI when made in an upward direction that falls within one of the following: between 20° either side of a straight line that begins at the starting point on the item 150 and runs perpendicular to and away from the bottom edge of the GUI (the central arrow of FIG. 6 which protrudes from the “start” or “touch” point “A” illustrates the straight line upward direction); between 40° either side of a straight line that begins at the starting point on the item 150 and runs perpendicular to and away from the bottom edge of the GUI; between 80° either side of a straight line that begins at the starting point on the item 150 and runs perpendicular to and away from the bottom edge of the GUI; and between 90° either side of a straight line that begins at the starting point on the item 150 and runs perpendicular to and away from the bottom edge of the GUI.

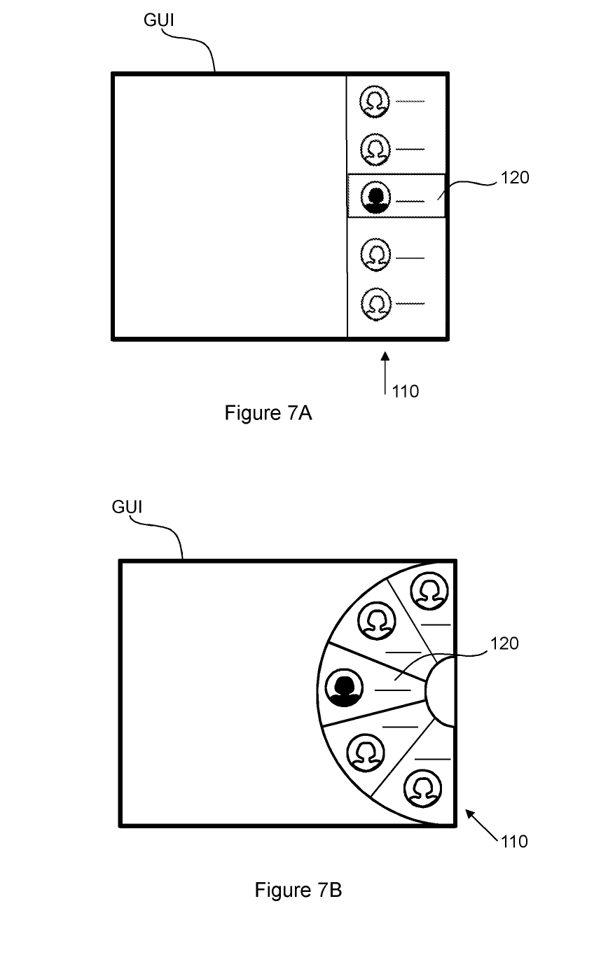

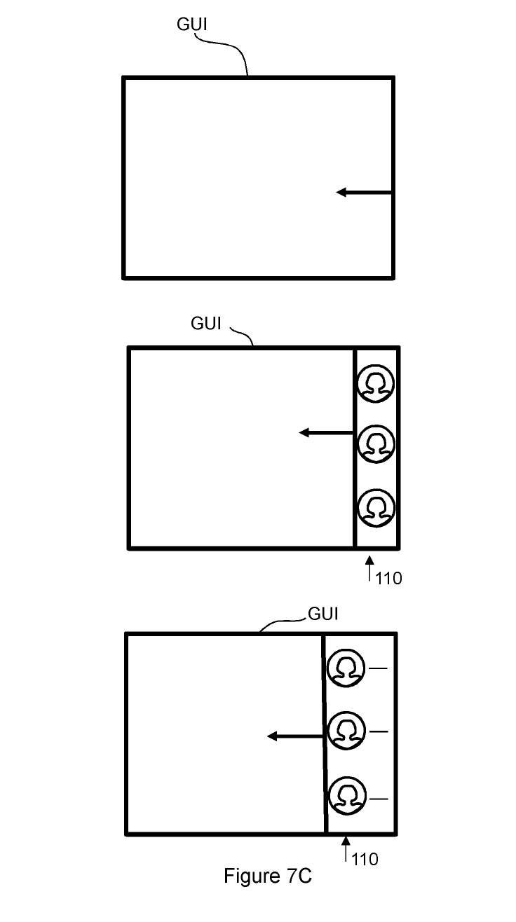

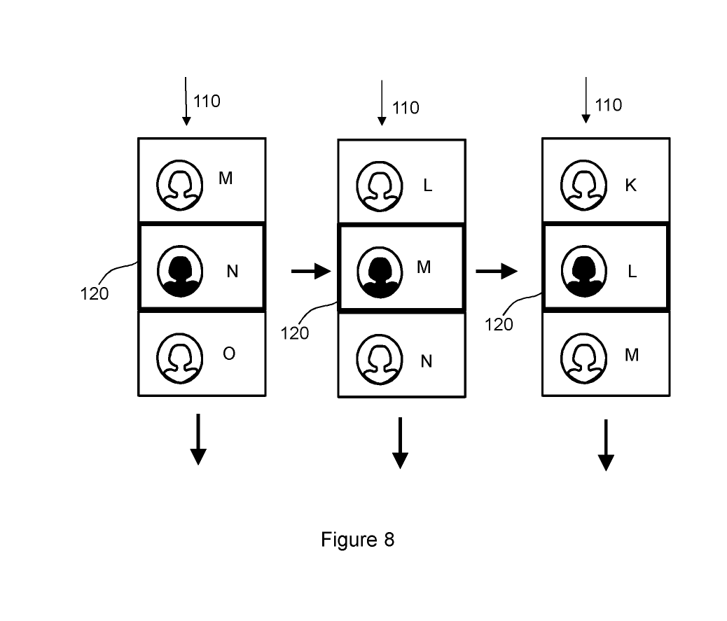

FIG. 7A shows the contact list 110 of the GUI as a vertically linear list. The contact list 110 is scrollable and the selected contact 120 is centrally displayed. The selected contact 120 is in bold and outlined to stand out from the remaining contacts in the contact list 110. The remaining contacts are greyed out to further emphasize the selected contact 120. The GUI only displays part of the contact list 110, i.e., not all of the plurality of contacts that make up the contact list 110 are displayed by the GUI at the same time. The contact list 110 is continuously scrollable in that the contact list will not reach an end during a scroll, rather the contact list will continue around in a loop to the first contact once the last contact has been reached. The contact list 110 in this example takes up approximately 25% of the width of the GUI. Optionally, the contact list 110 may take up 40%, 30%, 20% or 10% of the width of the GUI.

FIG. 7B shows the contact list 110 of FIG. 7A as a wheel-shaped contact list. The contact list may be ordered with the most recently used contact at or near the centre of the contact list.

FIG. 7C shows how the contact list 110 of FIG. 7A can be slid in and out of view. The wheel shaped contact list 110 of FIG. 7B can also be slid in and out of view. When the contact list 110 is slid into view it overlays anything already displayed by the GUI.

Looking to FIG. 8, it can be seen that the selected contact 120 can be reassigned as the user scrolls through the contact list 110. First, the selected contact 120 is contact N, clearly outlined and emboldened. As the contact list 110 is scrolled downwards the selected contact 120 is reassigned to contact M and then contact L. Although FIG. 8 depicts the scrolling in a downwards direction, the selected contact 120 can also be reassigned when the contact list 110 is scrolled in an upwards direction.

FIG. 9 shows a history of interactions 160 between the user and the selected contact 120 displayed in the main screen area 170. In this case, the selected contact has the name J. Bloggs. The history of interactions 160 is made up of a plurality of entries called: first entry 161, second entry 162, third entry 163 and fourth entry 164.

If the entries on the history of interactions 160 are related to file sharing, the entries themselves can be selected and are linked to content. Examples of such entries in FIG. 9 are the entries 161, 163 and 164. For example, first entry 161 states “09:05 J. Bloggs sent you a gift”, the user can click on first entry 161 and the gift received from J. Bloggs at 09:05 will appear in a window in the main display area 170. Being able to quickly and intuitively re-access files that were shared between the user and the selected contact means the user can shortcut the need to slowly search for the file in other applications such as an email application, or by browsing the memory of an electronic device.

For instance, a doctor who discussed and shared an X-ray of a patient with a specialist through the communication interface 100 can quickly retrieve and view the X-ray that was previously shared during a teleconference, simply by selecting on the appropriate contact and selecting the history, and then the file in question. This saves time and effort, and makes the use of video conferencing much more likely, thereby saving travel time and increasing the effectiveness of people at work.

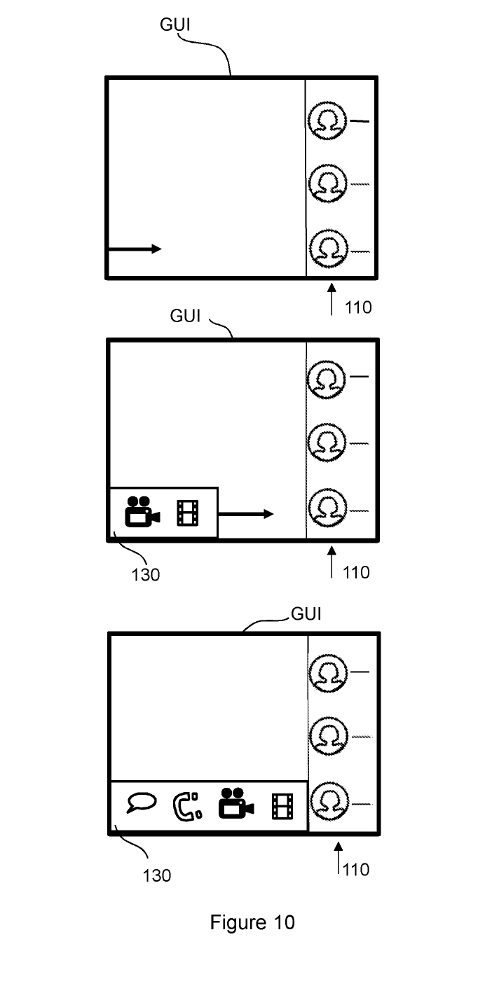

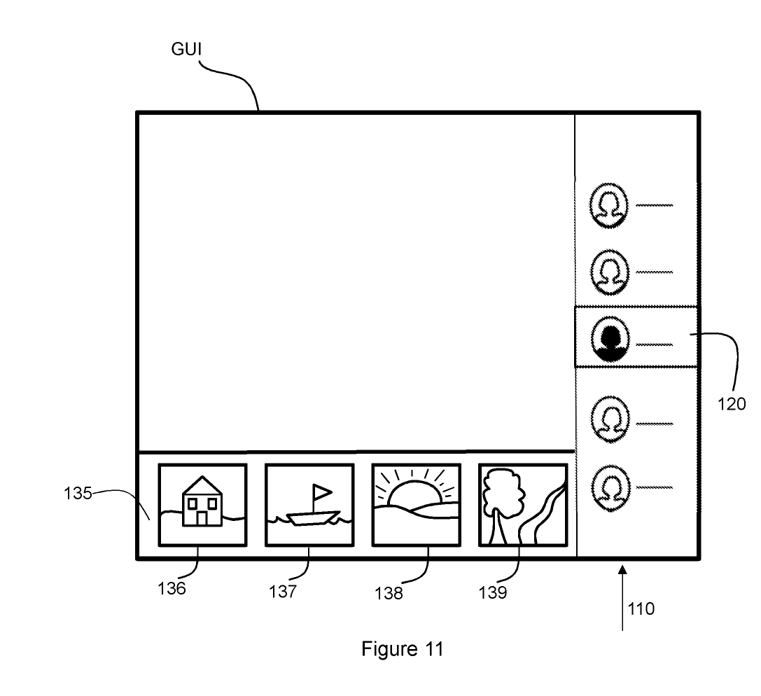

FIG. 10 shows the dashboard 130 of GUI. The dashboard 130 is initially hidden from view and is then slid in from the left-hand side of the GUI from the perspective of the user. The dashboard 130 is horizontal and linear. When the dashboard 130 is slid into view it overlays anything already displayed by the GUI.

The options on dashboard 130 include one or both of a voice or video call initiation option with a selected contact and one or a combination of the following file sharing options: photo sharing, video sharing, website sharing, editable text file sharing, doodle sharing, animation sharing, greeting sharing, e-book sharing, stored file sharing, PDF sharing, slideshow sharing, event invitation sharing, game play sharing.

One or a combination of the following options on dashboard 130 causes the GUI to display a window 140: photo sharing, video sharing, website sharing, editable text file sharing, event invitation sharing, and doodle sharing.

One or a combination of the following options on dashboard 130 causes the GUI to display a secondary dashboard 135 of items: photo sharing, video sharing, website sharing, animation sharing, greeting sharing, e-book sharing, stored file sharing, PDF sharing, slideshow sharing, event invitation sharing, game play sharing.

FIG. 11 depicts a secondary dashboard 135 relating to dashboard 130 of the GUI. Secondary dashboard 135 shows photo items 136, 137, 138 and 139 representative of photo files for sharing with a selected contact 120. The items relate to a selected option of the dashboard 130. Secondary dashboard 135 has been displayed by the GUI as a result of the picture sharing option being selected from initial dashboard 130. The secondary dashboard 135 replaces dashboard 130 in the GUI so that the dashboard 130 is no longer visible to the user.

As shown in FIG. 11, the photo items 136, 137, 138 and 139 for sharing are different digital images. Alternatively, the items may represent text or PDF documents.

Doodles, greetings, text documents, slide show presentations, spreadsheets, event invitations and other file formats can be created and edited by the user. A greeting can be created by adding text, a photo or a video. Further to this, doodles, greetings, text documents, slide show presentations, spreadsheets, event invitations and other file formats can be created and edited simultaneously by two or more users of the communication interface 100 (i.e. a user and a selected contact) together. The creation and editing of files can be performed when the interaction engine 200 is in an in-call mode (video or voice call taking place) or in an out-of-call mode (no video or voice call taking place). Whilst files are created and edited by two or more users of the communication interface 100, each user having an electronic device upon which their communication interface 100 is implemented, the two or more users may simultaneously use other features of the GUI, such as, reading a webpage or creating a design using the doodle option. The two or more users may receive data from multiple windows at the same time. For example, receiving news stories from a webpage whilst playing a video and sending an email.

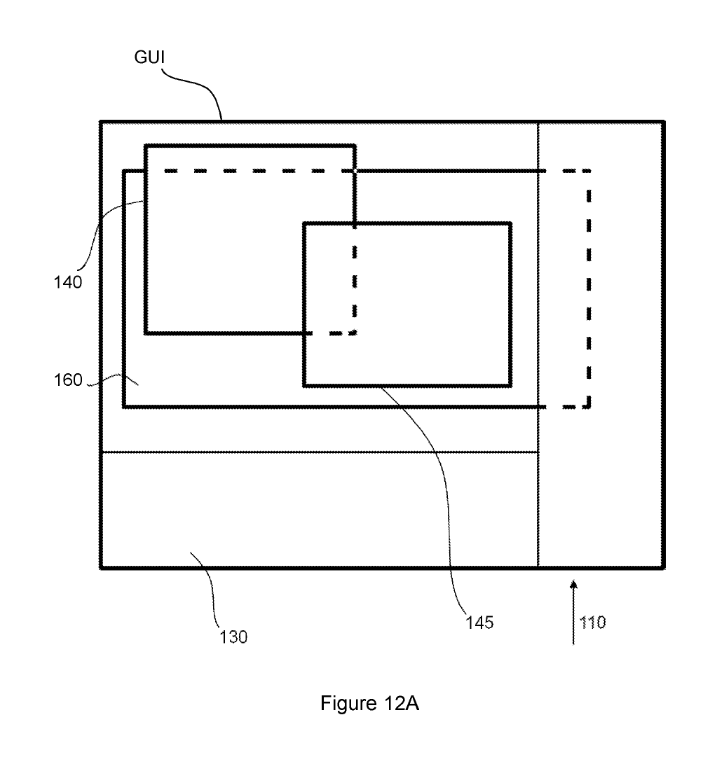

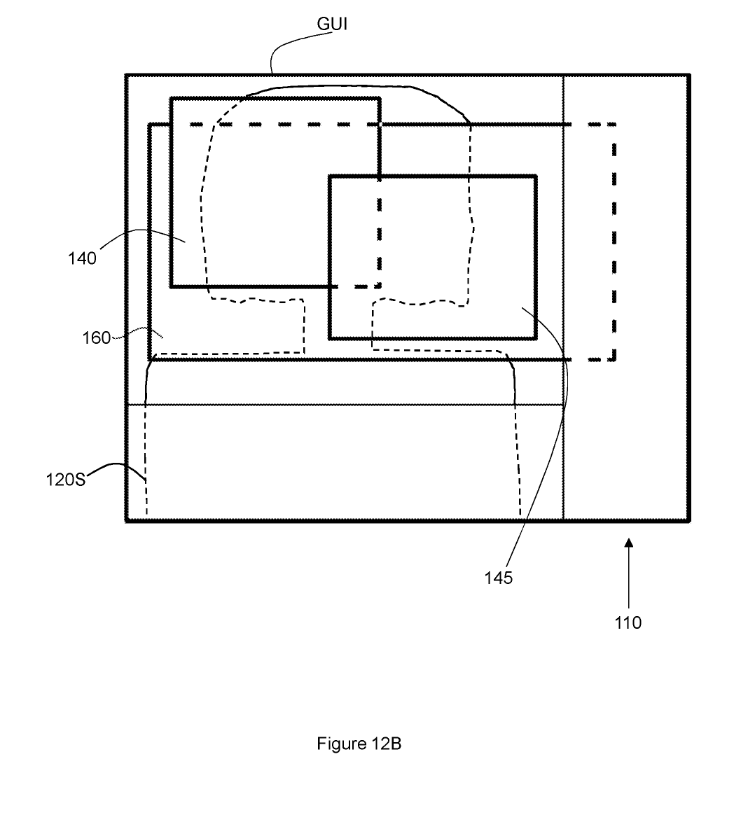

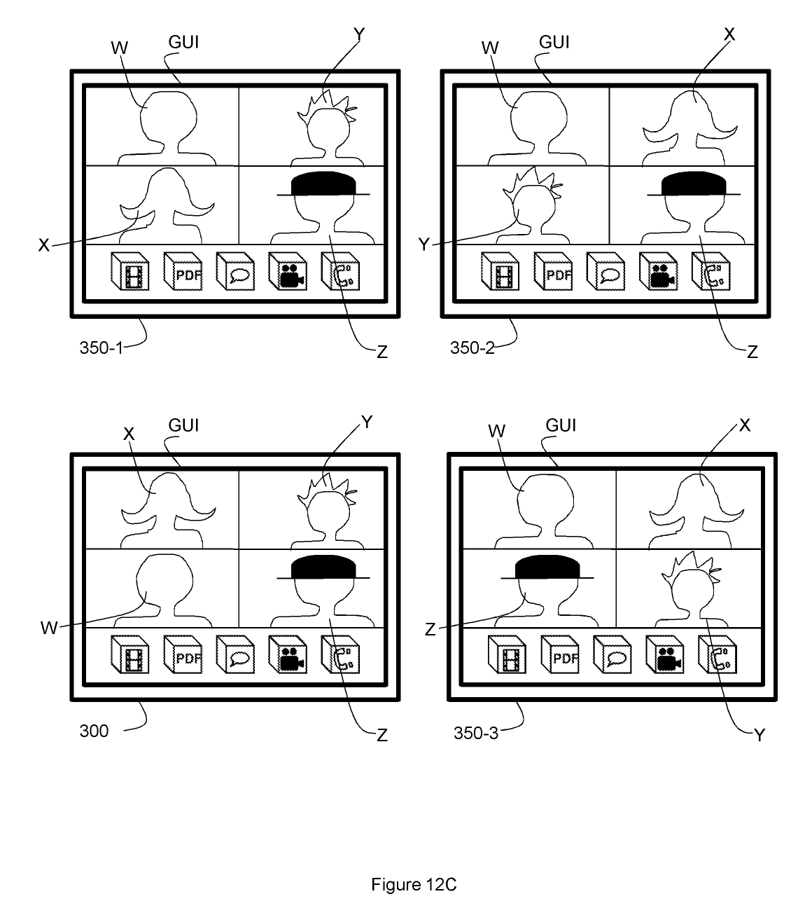

In FIG. 12A, it can be seen that the GUI displays the contact list 110, dashboard 130, main screen area 170 and any windows for creating files to share (e.g. window 140 and secondary window 145) in a multi-layered environment. The history of interactions 160 is the layer at the bottom of the multi-layered environment. The hashed lines of the right-hand side of the history of interactions 160 shows that the contact list 110 is above the history of interactions 160 in the multi-layered environment or stack of layers. Window 140 is above the history of interactions 160 in the stack of layers. Secondary window 145 is the latest window to be opened and is set above window 140. The hashed lines of window 140 show where the secondary window 145 overlaps window 140. Window 140 and secondary window 145 are open at the same time. Any number of files, windows, items can be opened on top of each other. If a user selects window 140 it is brought to the forefront of the multi-layered environment.

Window 140 and secondary window 145 are transparent, moveable and resizable independently of other objects displayed on the GUI.

FIG. 12B uses the same multi-layered environment as FIG. 12A. FIG. 12B shows the user in a video call with a selected contact 120. The outline 120S is representative of a video image of the selected contact 120. As shown in FIG. 12B the first and second windows, 140 and 145, the history of interactions 160, the dashboard 130 and the contact list 110 of FIG. 12A form layers in the multi-layered environment of the communication interface 100 and overlay the outline 120S. The hashed lines of the outline 120S show where the outline 120S is overlain by the layers of the multi-layered environment. When the outline 120S is overlain the hashed areas of the outline 120S may appear fainter or greyed out in comparison to the areas of the outline 120S which are not overlain. Optionally, the contact list 110 and dashboard 130 may be slid out of view as in FIGS. 7A-7C and FIG. 10, respectively.

The user of the communication interface 100 of FIG. 12B is able, whilst on a video call to selected contact 120, to create or view or edit files in windows 140 and 145. The user can also use a web browser or view an online video displayed by either of windows 140 or 145 at the same time as being engaged with the selected user 120 through the video call. Each component (such as contact list 110, history of interaction 130, dashboard 130, window 140 and window 145) of the multi-layered environment of FIG. 12B has a transparent background to minimise the amount of overlap with layers that sit below the component in question. For example, the windows 140 and 145 are transparent except for their content. This allows the user to maintain engagement and participation in a video call with selected contact 120 whilst viewing content in either of windows 140 or 145. Alternatively, if the user is in a voice call (rather than a video call) with the selected contact 120, there will of course be no outline 120S, and the user is able to create or view or edit files in windows 140 and 145. The user can also use a web browser or view an online video displayed by either of windows 140 or 145 at the same time as being engaged with the selected user 120 through the voice call.

FIG. 12C illustrates a multi-user video call between the user, represented by outline W, and selected contacts represented by outlines X, Y and Z. Each of the selected contacts represented by outlines X, Y and Z have respective selected contact devices 350-1, 350-2 and 350-3 upon which corresponding communication interfaces 100 are implemented and corresponding GUIs are displayed. Looking specifically to device 300 of the user W, outlines X, Y and Z of the other users involved in the multi-user video call are shown by the GUI of device 300. Video data received from each of the selected contact devices, 350-1, 350-2 and 350-3 is displayed in separate quadrants of the GUI. Optionally, the video data from selected contact devices 350-1, 350-2 and 350-3 may be displayed in individual windows by the GUI. Each window may then be moved and resized independently. When the user shares a file in a multi-user video call, such as the scenario of FIG. 12C, the file is shared automatically with each of the users taking part. In the example of FIG. 12C, selected contacts represented by outlines X, Y and Z would receive the shared file on their respective devices 350-1, 350-2 and 350-3.

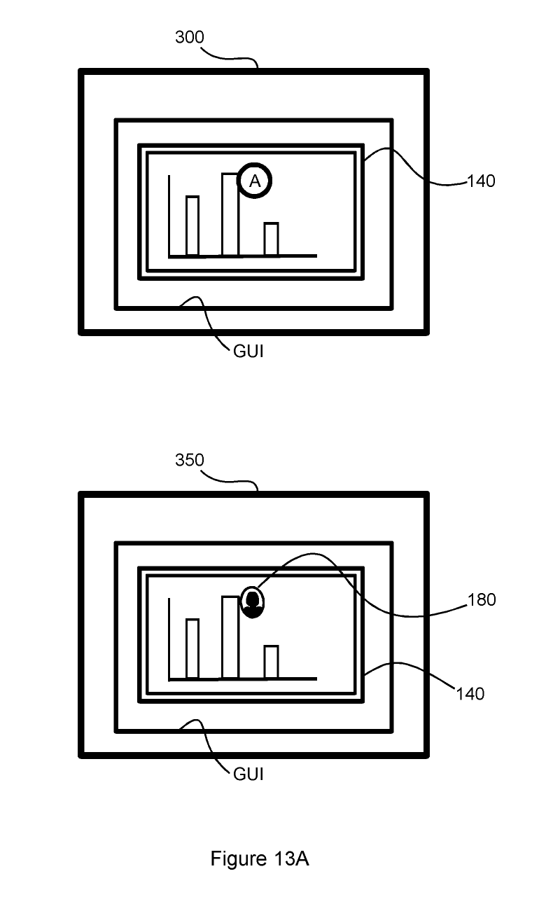

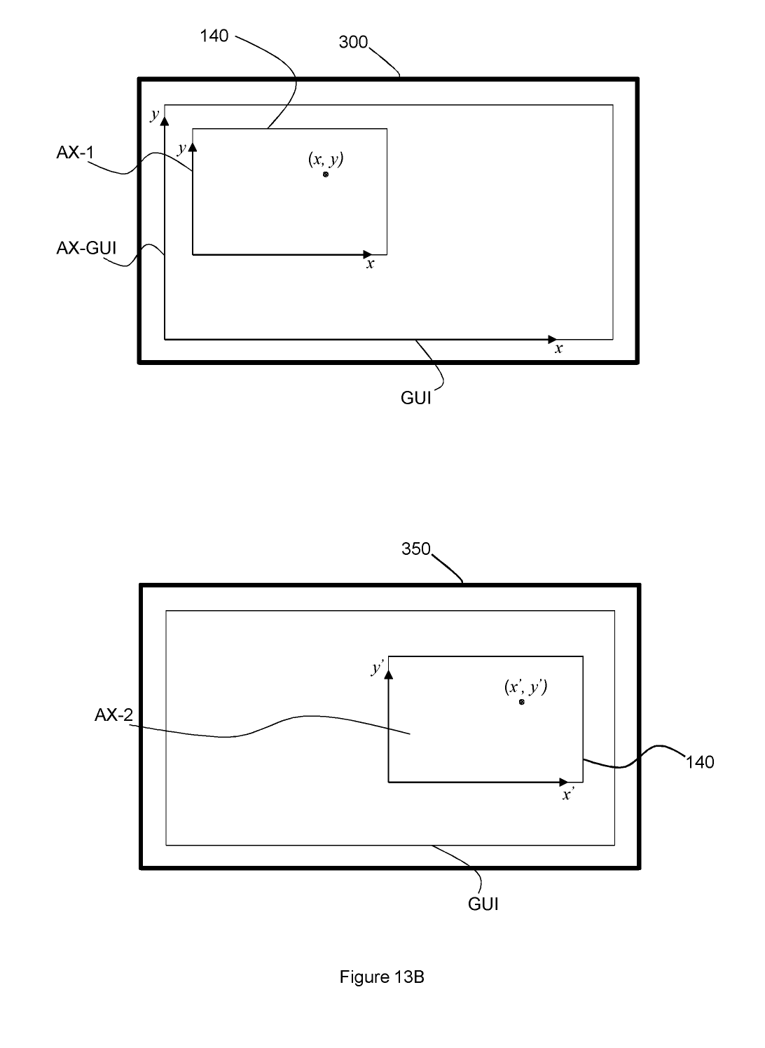

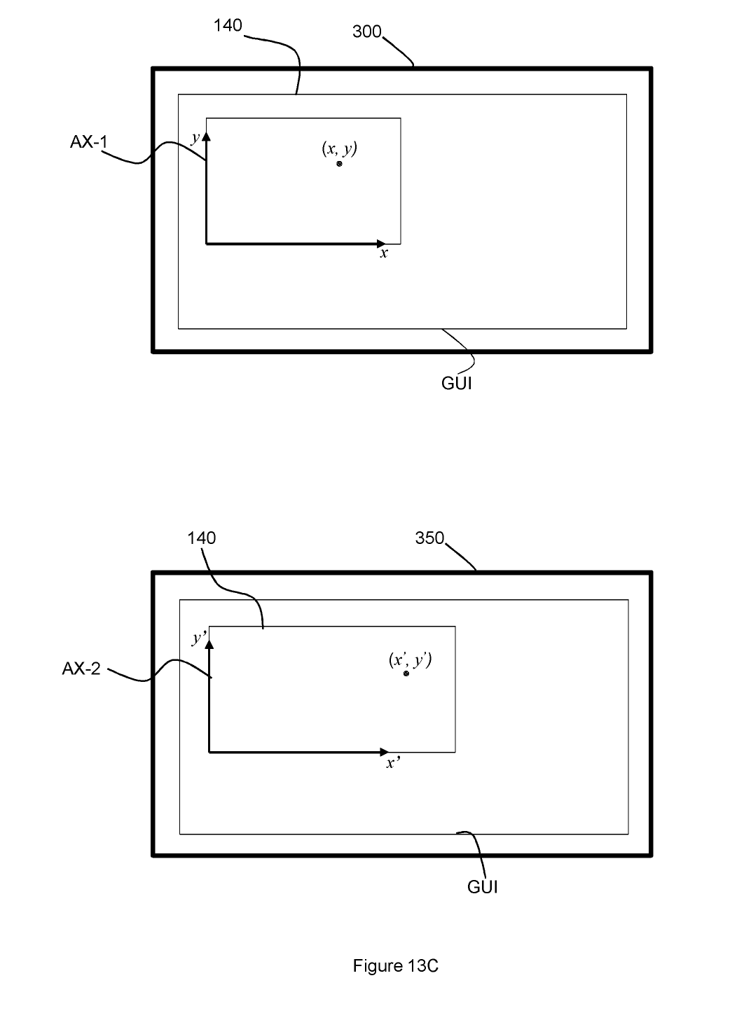

FIG. 13A compares the GUI of the user on the user device 300 with the GUI of the selected contact 120 on the selected contact device 350. The user and the selected contact 120 are sharing a slideshow presentation, or other digital file e.g. PDF document, a doodle, a webpage, an eBook, an event invitation, or a text document, with the user device 300 being the control device. The touch of the user on the GUI of the user device 300 is represented by the encircled “A”. The position of the touch of the user is transmitted to the selected contact device 350 and is represented by user identifier 180 associated with the user and is called the “digital finger” of the user. As shown in FIG. 13, the user identifier 180 is a picture of the user.

As an example, a parent away from home may read a bedtime story to their child through the communication interface 100. The digital finger of the parent may show as a picture of the parent on the GUI used by the child so that the child can see where their parent is pointing to on an eBook, for example. The digital finger may also help the parent encourage their child to read along by pointing to each word. The corresponding communication interfaces 100 used by the parent and child make the bedtime story experience as comforting to the child as possible through the combined use of video, eBook or file sharing, and the shared user identifier.

FIG. 13B shows how a touch event such as the touch “A” in FIG. 13A, occurring inside window 140 in the GUI of the user device 300, is mirrored in window 140 in the GUI of the selected contact device 350. The touch event occurs in the window 140 of the user device 300 at co-ordinates (x, y). Co-ordinates (x, y) are calculated using axis AX-1 that has an origin corresponding to the bottom left-hand corner of window 140. The touch event at (x, y) can be easily reproduced in window 140 of the selected contact device 350 at co-ordinates (x′, y′) because window 140 of the selected contact device 350 is the same size as window 140 in the GUI of the user device 300 and has an axis AX-2 that also has an origin at the bottom left hand corner of window 140. Specifically, x=x′ and y=y′. In more detail, the co-ordinates (x, y) are sent from the user device 300 to the selected contact device 350 in the same way as a file is shared in FIG. 3 and described in corresponding description. In this way, the positioning of both the windows 140 of the user device 300 and selected contact device 350 does not affect where the touch event (x, y) occurs in the GUI of the selected contact device 350. The positioning of touch events occurring inside a window are relative to the axis of the window (e.g. AX-1 of AX-2) and not relative to the axis of the GUI, AX-GUI.

The mirroring of co-ordinates of a touch event shown in FIG. 13B is also applicable to when files are edited by more than one user (each using a version of the communication interface 100) at the same time.

FIG. 13C shows how co-ordinates (x, y) in a user device 300 can be appropriately scaled and displayed as co-ordinates (x′, y′) in a selected contact device 350. As shown, the dimensions of window 140 displayed in the GUI of the user device 300 are not the same as the dimensions of window 140 displayed in the GUI of the selected contact device 350. Specifically, the edges of window 140 of the selected contact device 350 that align with the x′-axis are longer than the edges of the window 140 of the user device 300 that align with the x-axis. Generally, this means x≠x′. Thus, the co-ordinates of axis AX-1 are required to be scaled up when represented on axis AX-2. As such, x′=cx, where c is a constant. In a specific example, if the selected contact is working with a window 140 that is 10% larger than a window 140 of the user device 300 in the x′ direction, this means x′=1.1x. Alternatively, if a window 140 of the selected contact device 350 is reduced in the x′ direction by 20%, x′=0.8x. This scaling is also applicable in the y′ direction, and thus, y′=dy holds true, where d is a constant. Generally, the communication interface is capable of appropriately scaling touch co-ordinates in order to accurately display touch events. As such, the following equations can be applied in touch event scenarios and also when files are created or edited by the user and one or more selected contacts at the same time:

x′=cx (Equation 1)

y′−dy (Equation 2)

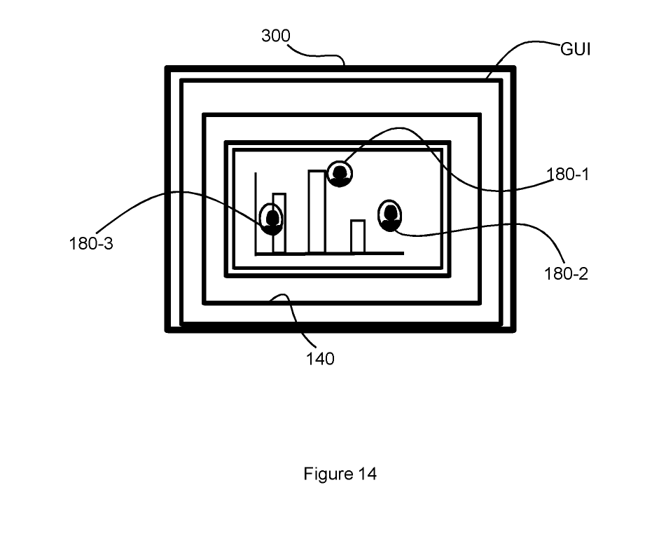

FIG. 14 displays a digital finger feature of the GUI in a multi-user voice call scenario on a device of the user 300. As shown, the GUI of the device of the user 300 displays user identifiers 180-1, 180-2 and 180-3 associated with a first, second and third selected contact taking part in the multi-user voice call. Each of the first, second and third selected contacts, associated with their respective identifiers 180-1, 180-2 and 180-3, can see the identifiers associated with the other participants of the multi-user voice call in their own GUI. For example, the second selected contact would see identifiers 180-1, 180-3 and an identifier associated with the user of device 300. In FIG. 14 the first, second, and third selected contacts are in a voice call discussing a bar chart. Using identifiers in a multi-user voice call scenario, such as the scenario shown in FIG. 14, is particularly useful because each participant is visually aware of where and to what each other participant is referring to. In this way, a multi-user voice call is clear, intuitive, interactive and more productive.

Alternatively, the user may be take part in a multi-user video call scenario of the GUI. In this instance, the identifiers of FIG. 14 still work in the same way. Although, the identifiers associated with each participant of the multi-user video call may be freeze frames of each video of each of the participants, or may even be smaller screened versions of the live video data displayed to the user of each participant taking part in the multi-user video call.

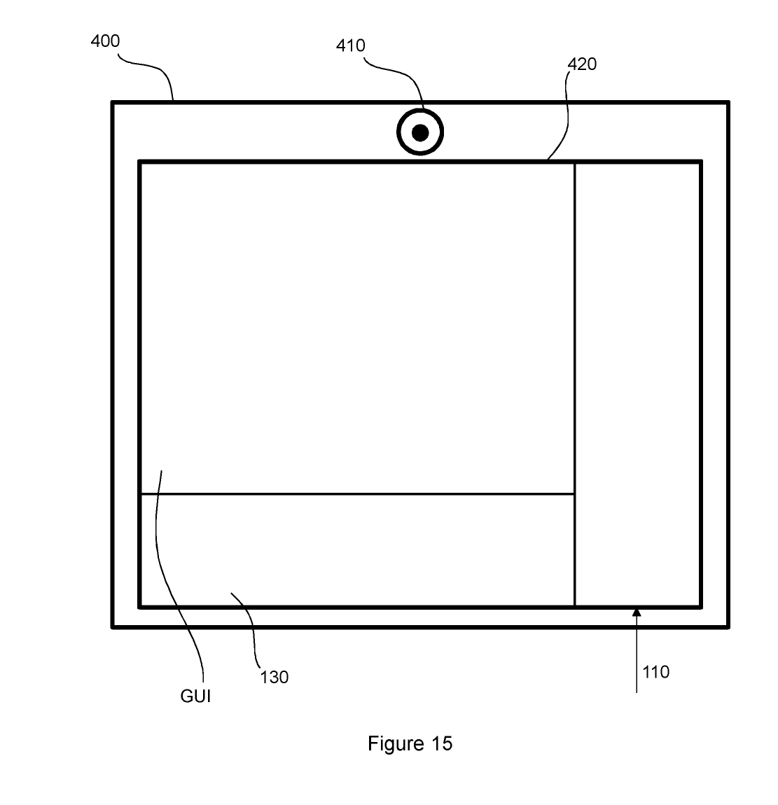

FIG. 15 shows a device 400 on which the communication interface 100 is used. The device 400 has a camera 410 and a touch screen display 420. The communication interface 100 has been downloaded onto device 400 as an application. The device 400 resembles a tablet however, as an alternative, device 400 may be a smartphone, desktop computer, laptop computer or a smart wearable device. The GUI occupies the whole of the visible display of the device 400.

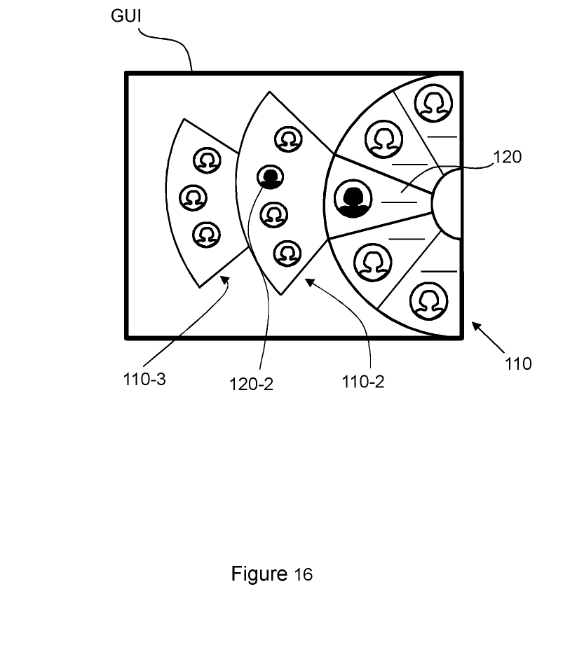

FIG. 16 shows the GUI displaying contact list 110 with selected contact 120. Selected contact 120 is representative of a group of contacts (all of which use their own versions of the communication interface and are therefore “users”) called secondary contacts. When selected contact 120 is selected from contact list 110 secondary contact list 110-2 is displayed. The secondary contact list 110-2 comprises a plurality of secondary contacts each of which are representative of a sub-group of contacts called tertiary contacts. FIG. 16 shows an emboldened selected contact 120-2 of contact list 110-2. When selected contact 120-2 is selected a tertiary contact list 110-3 is displayed. Contact lists 110, 110-2 and 110-3 are scrollable and wheel-shaped. Contact list 110-2 is connected to selected contact 120. Contact list 110-3 is connected to contact list 110-2. In a slight variation, contact list 110-2 may be displayed centred around or encircling selected contact 120 and contact list 110-3 may be displayed centred around or encircling selected contact 120-2. Contact list 110-2 may appear to move into view and extend from behind contact list 110. Alternatively, contact list 110-2 may appear to expand from selected contact 120. Contact list 110-3 may appear to move into view and extend from behind contact list 110-2. Alternatively, contact list 110-3 may appear to expand from selected contact 120-2. In an alternative embodiment, contact lists 110, 110-2 and 110-3 may be linear in shape and be positioned vertically, perpendicular to the bottom edge of the GUI. Practically, contact list 110 may contain a plurality of work contacts of the user. Selected contact 120 may be representative of the accounts group. The accounts group consists of secondary contacts in contact list 110-2. A selected contact 120-2 of the secondary contacts list 110-2 may be representative of a subgroup within the accounts group e.g. the expenses group represented by tertiary contacts in tertiary contact list 110-3.

The user may create groups of contacts such as “work”, “gym” and “family” groups. This allows the user to easily manage contacts and send files that are relevant to a certain group of people/contacts to each contact of the group simultaneously, saving time.

The creator of each group may have sole access to interact with or see each contact within the group. The creator may allow access to each group for selective contacts only.

Optionally, each group will have a history of interaction on a group page. As an example, the creator of the group may approve or disapprove files for sharing to the whole group. Optionally, each member of a group may invite others to join the group whereby when a user joins a group a group contact list is automatically added to the new group member's communications interface. Alternatively, a user may search for a group. A member may join a group by adding a mobile number of the group. In a slight iteration, members of the groups will receive notifications when another member shares a file to the group. Optionally, the group page may have live links to purchase products of the group or companies whereby payment for such products is enabled through the communication interface.

As an example, a landlord may require the inventory of the contents of a rental home to be signed by each of the potential tenants. The inventory may be a PDF file. Whether in a voice or video call or even in an out-of-call mode, the landlord, through the communication interface 100, is able to send each of the potential tenants the PDF file so that each potential tenant can sign and send back the inventory efficiently.

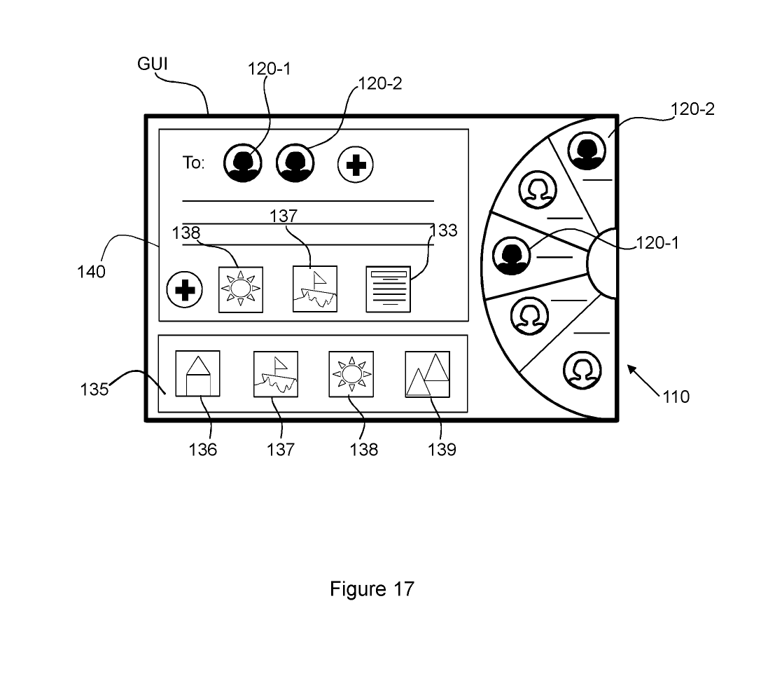

FIG. 17 shows a hybrid mail displayed by the GUI of the communications interface 100 in window 140. Hybrid mails may be a selectable option on dashboard 130. Hybrid mails send mail to selected contacts' devices without using email identification, and instead using a mobile phone number. Multiple selectable contacts are added to the recipient list by a flicking gesture from the contact list 110. In the specific example of FIG. 17, multiple selectable contacts can be added as recipients by flicking sideways from the contact list 110 towards the hybrid mail and multiple files can be added from the secondary dashboard 135 using the flick sharing gesture described in relation to FIG. 6, or a tap sharing gesture. Contacts may be removed from the recipient list of a hybrid mail by using a flick gesture away from the position of the contact to be removed in the recipient list. In the specific example of FIG. 17, contacts can be removed as recipients using a flick sideways towards the contact list 110. In FIG. 17 a first contact is selected from contact list 110 and becomes a first selected contact 120-1 and a second contact is selected from the contact list 110 and becomes a second selected contact 120-2. The hybrid mail is created in window 140 and displays the chosen recipients—selected contacts 120-1 and 120-2. Photo files 136, 137 and text document 133 have been added to the hybrid mail from secondary dashboard 135. The photo files 136, 137 and the text document 133 have been added to the hybrid mail using an upwards flick sharing gesture.

A range of files can be added to a hybrid mail of the communication interface 100 such as text documents, doodles, gifts, greetings, slide show presentations, spreadsheets, animations, PDF documents and eBooks.

The file for sharing may in fact be saved on the communications server 310.

The user may share files with a plurality of selected contacts.

Each one of the plurality of contacts displayed by the contact list 110 may be representative of a single contact or one or more single contacts i.e. a group of contacts. For example, there may be a contact representative of a company, the contact may be linked to a group of users such as those that make up the finance department. There may be subgroups of contacts/users within each group of contacts/users such as a tax group inside a finance group. Contacts in a group may be secondary contacts. Contacts in a subgroup may be tertiary contacts

Secondary dashboard 135 may overlay dashboard 130, overlap dashboard 130 or be set above dashboard 130.

The type of files for sharing include Word files, Excel files, PowerPoint files, PDF, .txt files, .doc files, HTML files, .jpg files and .tif files.

The options on dashboard 130 may include a Dropbox (RTM) account or other data storage location. The dashboard may include links to company websites or adverts.

The options may include online videos i.e. YouTube (RTM) or sponsored web links such as Groupon (RTM).

With the drag-and-drop feature the window 140 may be dropped into any position along the contact list 110.

The two fingered sharing gesture could be in a sideward direction or a downwards direction.

An item may be shared from the secondary dashboard 135 using a tap sharing gesture.

The selected contact 120 may glow and/or be made brighter and/or bigger than the other contacts. The other contacts may be faded, blurred out or smaller than the selected contact. The selected contact 120 may be displayed at the top of the contact list 110.

Turning the wheel-shaped contact list 110 in a clockwise or anticlockwise direction may reassign the selected contact 120.

The dashboard 130 may be wheel-shaped. The secondary dashboard 135 may be wheel-shaped. The dashboard 130 may be vertically aligned on the opposite side of the GUI to the contact list 110. The secondary dashboard 135 may be vertically aligned on the opposite side of the GUI to the contact list 110.

Secondary dashboard 135 may slide in and out from the left-hand side of the GUI, from the perspective of the user, to become visible and then hidden.

Dashboard 130 may come in to view when the contact list 110 is opened or slid into view. Dashboard 130 may hide from view when contact list 110 is closed or slid out of view. This has the effect of de-cluttering the GUI display making it clearer for the user to use.

Secondary dashboard 135 may come in to view when the contact list 110 is opened or slid into view. Secondary dashboard 135 may hide from view when contact list 110 is closed or slid out of view. This has the effect of de-cluttering the GUI display making it clearer for the user to use.

The items on the secondary dashboard 135 may be videos, websites, animations, greetings, e-books, stored files, PDFs, slideshows, or games.

The contact list, dashboard and/or secondary dashboard may automatically resize to accommodate for gestures, calls, windows or creation of files to share.

The contact list, dashboard and secondary dashboard may list content/data in chronological order.

A multi-layered environment of the GUI may be established over a live video or voice call.

Windows that correspond to window 140 are created for file sharing. Preferably, such windows allow the user to create a file for sharing and also display files to be shared e.g. web pages, eBooks. Preferably, window 140 displays any file whether the file is to be shared or not.

The most recent windows created for file sharing may become the top layer of the overlaid windows. This may happen whether the interaction engine 200 is in an in-call mode or an out-of-call mode.

When the interaction engine 200 is in an in-call mode with a selected contact 120, the user may add other contacts from the contact list 110 into the call. The user may send a request to a desired contact. Once the request has been accepted the desired contact joins the call/chat.

The GUI may constantly display the profile name, location, picture and status of the user.

The GUI may display an advert bar. The advert bar may be displayed on the history of interactions and also during a voice or video call as an overlay. Optionally, the adverts may be a moving display or flashing or floating. The advert may be clicked to open an overlaying window within the communications interface 100. The adverts may be location specific to the user.

The GUI may also display information to the user such as weather, news, the stock exchange or astrology.

The user identifier 180 may be a name, a nickname or an ID number.

The communication interface 100 provides a fluid, interactive, efficient and dynamic way for a user to communicate with, share, and work on files with a chosen recipient or recipients. The communication interface 100 allows files to be exchanged during or outside of a voice or video conference in a smooth and efficient way, thereby saving time, encouraging remote sharing, and thereby travel, and, as a result, reducing carbon emissions.

The communication interface 100 provides a platform for other developers to add their applications to the dashboard 130.

Although the invention has been described above with reference to one or more preferred embodiments, it will be appreciated that various changes or modifications may be made without departing from the scope of the invention as defined in the appended claims.

1. A communication interface for allowing interaction between two or more users, the communication interface comprising:
a graphical user interface (GUI); and
an interaction engine for facilitating interactions between a user and one or more user contacts;
wherein:
the interaction engine is arranged to facilitate voice, video and file sharing interactions between the user and one or more user contacts through the GUI, and is arranged to be in an out-of-call mode or in an in-call mode in relation to voice and video interactions of the user; and
the GUI is arranged to:
display a contact list containing a plurality of user contacts, wherein one of the plurality of contacts is a selected contact;
display a dashboard containing a plurality of options for interacting with the selected contact, each option arranged to enable the user to interact with the selected contact by voice, video or file sharing interactions; and
display, on selection of an option relating to file sharing and depending on the selection, a window so that the user is able to create a file for sharing, or a secondary dashboard comprising an item representing a file for sharing with the selected contact;
wherein the interaction engine is arranged to share the file for sharing with the selected contact on receipt of a sharing gesture from the GUI in relation to the window or item, whether or not the interaction engine is in the out-of-call mode or the in-call mode.

2. The communication interface of claim 1, wherein the file for sharing is capable of being created and edited by the user and the selected contact at the same time.

3. The communication interface of claim 1 wherein the sharing gesture is one of the following: a tap gesture; a flick gesture, a two-finger slide gesture; a drag-and-drop gesture.

4. The communication interface of claim 1 wherein the sharing gesture is a drag-and-drop gesture or a two-finger slide gesture when the sharing gesture relates to the window.

5. The communication interface of claim 1 wherein the sharing gesture is a drag-and-drop gesture when the sharing gesture relates to the window and the interaction engine is in an out-of-call mode.

6. The communication interface of claim 1 wherein the sharing gesture is a two-finger slide gesture when the sharing gesture relates to the window and the interaction engine is in an in-call mode with the selected contact.

7. The communication interface of claim 1 wherein the sharing gesture is a one-finger slide gesture.

8. The communication interface of claim 1 wherein the window is shared with the selected contact so that the selected contact is shown the window.

9. The communication interface of claim 1 wherein the sharing gesture is a tap gesture or a flick gesture when the sharing gesture relates to the item.

10. The communication interface of claim 1 wherein the sharing gesture is a tap gesture or a flick gesture when the sharing gesture relates to the item and the interaction engine is in an in-call mode or an out-of-call mode.

11. The communication interface of claim 1 wherein the sharing gesture is a flick.

12. The communication interface of claim 1 wherein the contact list is a scrollable contact list.

13. The communication interface of claim 1 wherein the contact list displays contacts in order of most recent interaction.

14. The communication interface of claim 1, wherein in each one of the plurality of contacts of the contact list is representative of a group of one or more secondary contacts.

15. The communication interface of claim 1 wherein the GUI is arranged to allow the contact list to slide in and out of view.

16. The communication interface of claim 1 wherein the GUI is arranged to provide a multi-layered environment for the contact list, dashboard, and one or more windows.

17. The communication interface of claiml wherein each window is transparent.

18. The communication interface of claim 1 wherein each window is moveable and resizable independently from other objects in the GUI.

19. The communication interface of claim 1 wherein, during a video or voice call with the selected contact, the GUI is arranged to display incoming video data from the selected contact and optional location data of the selected contact, and the GUI is arranged to overlay any windows that are created for file sharing or which are received from the selected contact in the incoming video data.

20. The communication interface of claim 1 wherein the GUI is arranged to allow the dashboard to slide in and out of view.
